(19) United States
(12) Patent Application Publication
(10) Pub. No.: US 2009/0102142 A1
(43) Pub. Date: Apr. 23, 2009

(54) SEALING MATERIAL

(75) Inventors: Hiroyuki Tanaka, Osaka (JP); Seiichi Hirano, Osaka (JP); Yasuhiro Sakamoto, Osaka (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD., Osaka-shi, Osaka (JP)

(21) Appl. No.: 12/063,331

(22) PCT Filed: Jul. 7, 2006
(86) PCT No.: PCT/JP2006/313563

§ 371 Date: Feb. 8, 2008

(30) Foreign Application Priority Data
Aug. 10, 2005 (JP) 2005-232206

(51) Int. Cl. F16J 15/10

(52) U.S. Cl. 277/650

(57) ABSTRACT

The present invention provides a sealing material comprising a fluorine-containing elastomer, which can be mounted without torsion because the torsion can be easily confirmed when mounting the sealing material. The sealing material comprises a fluorine-containing elastomer and is provided with marking on a surface of a seal ring along its shape.

### TECHNICAL FIELD

The present invention relates to a sealing material comprising a fluorine-containing elastomer, which can be mounted without torsion because the torsion can be easily confirmed when mounting the sealing material.

### BACKGROUND ART

Fluorine-containing elastomers, especially perfluoro elastomers mainly comprising a tetrafluoroethylene (TFE) unit, exhibit excellent chemical resistance, solvent resistance and heat resistance, and therefore, are widely used as a sealing material under strict environment in the fields of aeroplane and space, semiconductor manufacturing equipment and chemical plants.

In a process for manufacturing semiconductors, elastomeric sealing materials are used to seal various connection parts and movable parts of a variety of equipment to be used. Particularly O-rings having a cross-section of a circular shape are generally used as a sealing material for dovetail grooves. However there is a problem that torsion is easily caused when mounting on a dovetail groove. In addition, in the case of conventional O-rings, since such torsion is hardly observed visually, in some cases, an O-ring having such torsion is used as it is, which causes leakage through the seal and breakage in a short period of time, thereby being unable to exhibit essential performances of the sealing material.

Further in a process for manufacturing semiconductors, CVD is employed in a step for forming an insulating film or a thin metallic wire film. In CVD equipment, elastomeric sealing materials are used to seal various connection parts and movable parts thereof. In the inside of such equipment, since strict plasma treating conditions of a high density (10¹² to 10¹³/cm³) are adopted, when sealing is made with torsion being left as it is, there are problems that damage due to plasma emission is easily caused and a speed for reaching a high degree of vacuum is slow.

In order to solve the mentioned problems, various techniques relating to a shape of a cross-section of a sealing material and a shape of groove have been proposed (for example, cf. JP10-318373A, JP11-336909A, JP2003-14126A and WO96/21814). However in any of these proposals, since complicated shapes are proposed, there are many problems in processing and cost is high.

Such being the case, the present situation is such that there is no elastomeric sealing material which makes it possible to easily confirm degree of torsion at mounting the sealing material and can be mounted without causing torsion.

### DISCLOSURE OF INVENTION

The present invention provides a sealing material comprising a fluorine-containing elastomer which makes it possible to easily confirm degree of torsion at mounting the sealing material and can be mounted without causing torsion.

Namely, the present invention relates to a sealing material comprising a fluorine-containing elastomer and having marking provided on a surface of a seal ring along its shape.

It is preferable that the marking is provided in series in a linear form along a shape of a sealing material in a plane view.

It is preferable that the fluorine-containing elastomer is a perfluoro elastomer.

It is preferable that the marking is made by laser printing.

### BRIEF DESCRIPTION OF THE DRAWINGS

FIG. 1 A top view of the sealing material of the present invention.

FIG. 2 (a): A top view of the sealing material of the present invention.
(b): A cross-sectional view of XX of the sealing material of (a).

FIG. 3 A top view of the sealing material of the present invention.

FIG. 4 A top view of the sealing material of the present invention.

FIG. 5 A top view of the sealing material of the present invention.

FIG. 6 A top view of the sealing material of the present invention.

FIG. 7 (a): A top view of the sealing material of the present invention.
(b): A cross-sectional view of YY of the sealing material of (a).

### BEST MODE FOR CARRYING OUT THE INVENTION

The present invention relates to a sealing material comprising a fluorine-containing elastomer and having marking provided on a surface of a seal ring along its shape.

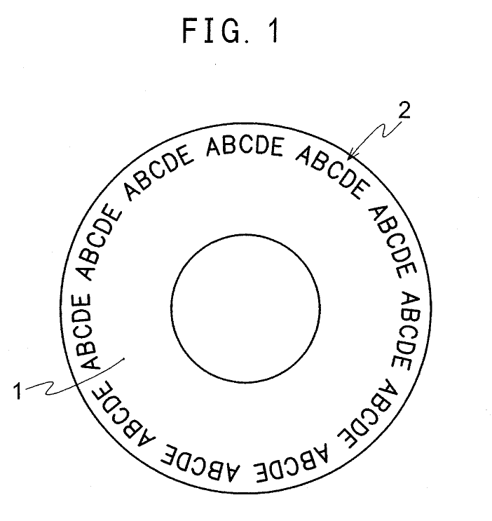

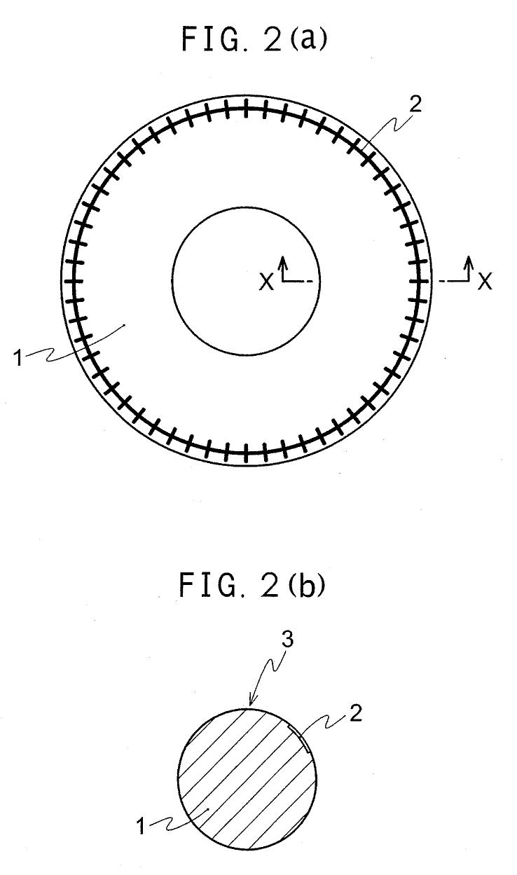

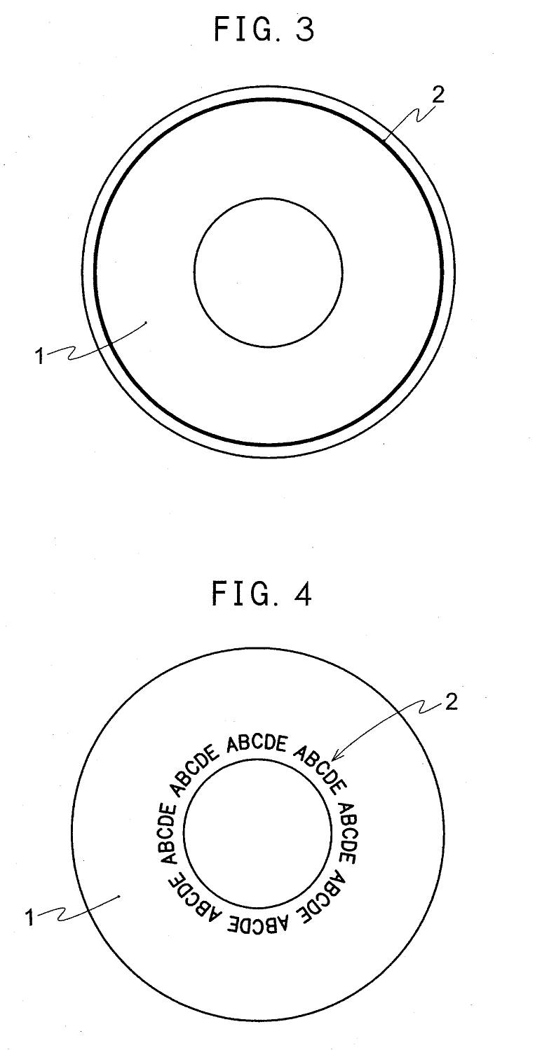

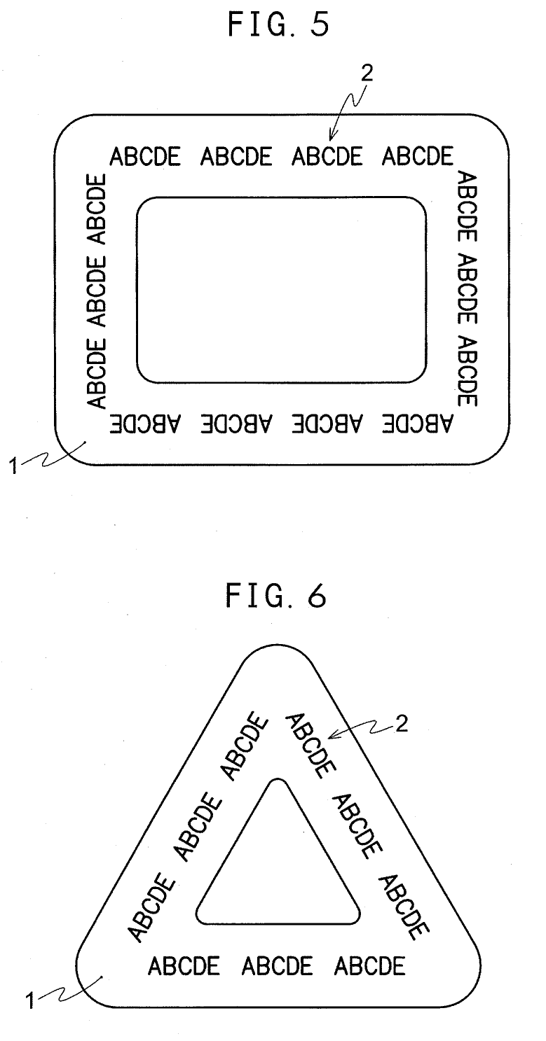

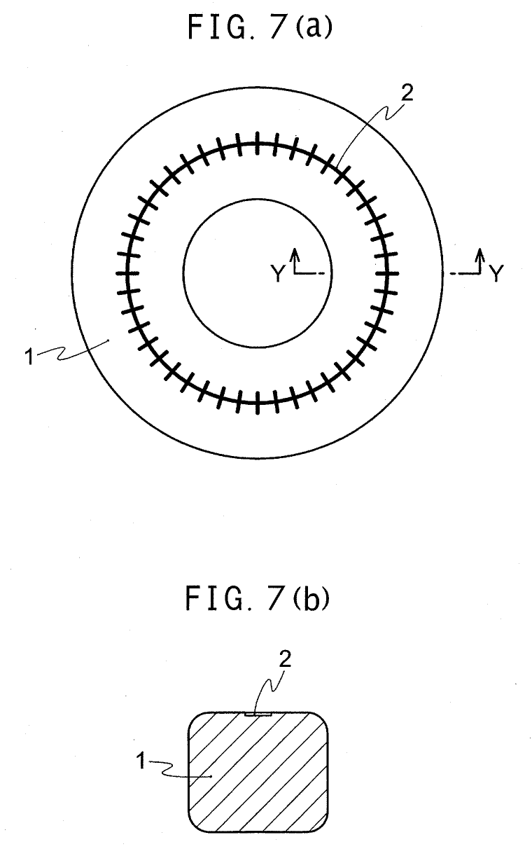

Examples of the marking are a line, a character, a pattern and a combination thereof. The marking is not limited particularly and may be one which is provided in series in a linear form along a shape of the sealing material in a plane view as described in FIGS. 1 to 7 because degree of torsion is easily observed at mounting the sealing material.

Here the plane view means viewing the seal ring from a vertical direction, and corresponds to a top view as shown in FIGS. 1, 2(a), 3 to 6 and 7(a).

A location of the marking is not limited particularly as far as the marking is not hidden by a dovetail groove and can be seen. For example, when the seal ring is an O-ring, the marking is preferably located at a part other than a top of the sealing material because the marking on the top of the sealing material may have an adverse effect on performance of the sealing material. Here the top of the sealing material is the highest portion of the sealing material as shown in FIG. 2(b). It is further preferable to make the marking at the side where the performances of the sealing material including durability and cleanness are not adversely affected.

The marking method is not limited particularly, and examples thereof are, for instance, laser printing, silk screen printing, ink jet printing and pad printing. Among them, laser printing is preferable from the viewpoint of a printing speed, suitability to a shape, durability and cleanness

Laser printing can be conducted using a laser marker which is generally used. Kind of laser may be optionally selected depending on a starting material of the sealing material, a shape of the sealing material, etc. For example, carbon dioxide gas laser, YAG laser or YVO₄ laser can be used.

In the present invention, the shape of the fluorine-containing elastomer seal ring, the surface of which is to be marked, is not limited particularly, and may be in the form of ring in a plane view. Various shapes can be used, for example, circular, square, triangular and rectangular shapes.

In addition, a shape of a cross-section of the fluorine-containing elastomer seal ring is not limited particularly, and various two-dimensional shapes such as a circular shape, an elliptical shape, a polygonal shape and a polygonal shape with rounded corners can be used. Among them, a circular shape and a polygonal shape with rounded corners are preferable from the viewpoint of a stress and strain to be applied to the rubber. The polygonal shape with rounded corners is one having each corner rounded to an elliptical arc as shown in FIG. 7(b).

Examples of the seal ring are O-ring, square ring, packing, gasket, oil seal, bearing seal and lip seal. The seal ring is preferably O-ring or square ring since effects of the present invention can be obtained.

In the present invention, the fluorine-containing elastomer seal ring to be provided with the marking on its surface is not limited particularly, and any of fluorine-containing elastomer seal rings used for semiconductor manufacturing equipment can be used. Especially for plasma generating equipment, a seal ring made of a perfluoro elastomer is preferable from the viewpoint of chemical resistance, heat resistance and resistance to any of plasma.

A fluorine-containing elastomer suitably used in the present invention is not limited particularly as far as it is used for a sealing material, especially for a sealing material for semiconductor manufacturing equipment.

Examples of the fluorine-containing elastomer are a fluorine-containing rubber (a), a thermoplastic fluorine-containing rubber (b) and a rubber composition comprising such a fluorine-containing rubber.

Examples of the fluorine-containing rubber (a) are a non-perfluoro fluorine-containing rubber (a-1) and a perfluoro fluorine-containing rubber (a-2).

Examples of the non-perfluoro fluorine-containing rubber (a-1) are fluorine-containing vinylidene fluoride (VdF) rubbers, fluorine-containing tetrafluoroethylene (TFE)/propylene rubbers, fluorine-containing tetrafluoroethylene (TFE)/propylene/vinylidene fluoride (VdF) rubbers, fluorine-containing ethylene/hexafluoropropylene (HFP) rubbers, fluorine-containing ethylene/hexafluoropropylene (HFP)/vinylidene fluoride (VdF) rubbers, ethylene/hexafluoropropylene (HFP)/tetrafluoroethylene (TFE) rubbers, fluorine-containing fluorosilicone rubbers and fluorine-containing fluorophosphazene rubbers. These can be used solely or can be used in optional combination to an effect not to impair the effect of the present invention.

Fluorine-containing vinylidene fluoride rubbers are fluorine-containing elastomers comprising 45 to 85% by mole of vinylidene fluoride and 55 to 15% by mole of at least one other monomer copolymerizable with vinylidene fluoride, preferably fluorine-containing elastomers comprising 50 to 80% by mole of vinylidene fluoride and 50 to 20% by mole of at least one other monomer copolymerizable with vinylidene fluoride.

Examples of at least one other monomer copolymerizable with vinylidene fluoride are, for instance, fluorine-containing monomers such as tetrafluoroethylene (TFE), chlorotrifluoroethylene (CTFE), trifluoroethylene, hexafluoropropylene (HFP), trifluoropropylene, tetrafluoropropylene, pentafluoropropylene, trifluorobutene, tetrafluoroisobutene, perfluoro(alkyl vinyl ether) (PAVE) and vinyl fluoride, and non-fluorine-containing monomers such as ethylene, propylene and alkyl vinyl ether. These can be used solely or can be used in optional combination. Among these, tetrafluoroethylene, hexafluoropropylene and perfluoro(alkyl vinyl ether) are preferably used.

Examples of the rubber are a VdF-HFP rubber, a VdF-HFP-TFE rubber, a VdF-CTFE rubber and a VdF-CTFE-TFE rubber.

Fluorine-containing tetrafluoroethylene/propylene rubbers are fluorine-containing copolymers comprising 45 to 70% by mole of tetrafluoroethylene, 55 to 30% by mole of propylene, and further 0 to 5% by mole of a monomer giving a cure site based on the total amount of tetrafluoroethylene and propylene.

Examples of the monomer giving a cure site are iodine-containing monomers such as perfluoro(6,6-dihydro-6-iodo-3-oxa-1-hexene) and perfluoro(5-iodo-3-oxa-1-pentene) disclosed in JP5-63482B and JP7-316234A; bromine-containing monomers disclosed in JP4-505341A; and cyano-containing monomers, carboxyl group-containing monomers and alkoxycarbonyl group-containing monomers disclosed in JP4-505345A and JP5-500070A.

Those non-perfluoro fluorine-containing rubbers (a-1) can be prepared by usual methods. Examples of commercially available non-perfluoro fluorine-containing rubbers (a-1) are, for instance, DIEL G-800 series and G-900 series available from DAIKIN INDUSTRIES, LTD.

Examples of the perfluoro fluorine-containing rubbers (a-2) are fluorine-containing elastomers comprising tetrafluoroethylene, perfluoro(alkyl vinyl ether) and a monomer giving a cure site. The proportion of tetrafluoroethylene to perfluoro(alkyl vinyl ether) is preferably 50 to 90/10 to 50 (% by mole), more preferably 50 to 80/20 to 50 (% by mole), further preferably 55 to 70/30 to 45 (% by mole). An amount of monomer giving a cure site is preferably 0 to 5% by mole, more preferably 0 to 2% by mole based on the total amount of tetrafluoroethylene and perfluoro(alkyl vinyl ether). If the proportions of these components are beyond the above-mentioned ranges, properties of elastic rubber are lost, and properties of the rubber tend to be akin to those of a resin.

In that case, examples of the perfluoro(alkyl vinyl ether) are, for instance, perfluoro(methyl vinyl ether), perfluoro(propyl vinyl ether) and the like. Those can be used alone or can be used in optional combination to an extent not to impair the effect of the present invention.

Examples of the monomer giving a cure site are, for instance, iodine- or bromine-containing monomers represented by the general formula (1):

CX¹₂═CX¹—R_{f}¹CHR¹X² (1)

wherein X¹ is H, F or CH₃; R_{f}¹ is a fluoroalkylene group, a perfluoroalkylene group, a fluoropolyoxyalkylene group or a perfluoropolyoxyalkylene group; R¹ is H or CH₃; X² is an iodine atom or a bromine atom, and
monomers represented by the general formula (2):

CF₂═CFO(CF₂CF(CF₃)O)ₘ(CF₂)ₙ—X³ (2)

wherein m is 0 or an integer of 1 to 5; n is an integer of 1 to 3; X³ is a cyano group, a carboxyl group, an alkoxycarbonyl group or a bromine atom. These can be used alone or can be used in optional combination.

These iodine atom, cyano group, carboxyl group, alkoxycarbonyl group and bromine atom can function as a cure site.

The perfluoro fluorine-containing rubber (a-2) can be prepared by usual methods.

Examples of the perfluoro fluorine-containing rubber (a-2) are fluorine-containing rubbers disclosed in WO97/24381, JP61-57324B, JP4-81608B and JP5-13961B.

In the present invention, curing can be carried out by using, for example, a curing agent of a peroxide crosslinking system, a polyol crosslinking system, a polyamine crosslinking system, an oxazole crosslinking system, an imidazole crosslinking system or a thiazole crosslinking system. In addition, triazine crosslinking can be carried out by using a catalyst for triazine crosslinking.

A curing agent to be used in peroxide crosslinking may be organic peroxides being capable of easily generating peroxy radicals in the presence of heat or an oxidation-reduction system. Examples thereof are, for instance, 1,1-bis(t-butylperoxy)-3,5,5-trimethylcyclohexane, 2,5-dimethylhexane-2,5-dihydroperoxide, di-t-butyl peroxide, t-dibutylcumyl peroxide, dicumyl peroxide, α,α-bis(t-butylperoxy)-p-diisopropylbenzene, 2,5-dimethyl-2,5-di(t-butylperoxy)hexane, 2,5-dimethyl-2,5-di(t-butylperoxy)hexyne-3, benzoyl peroxide, t-butyl peroxybenzene, 2,5-dimethyl-2,5-di(benzoylperoxy)hexane, t-butylperoxy maleic acid and t-butylperoxy isopropylcarbonate. Generally kind and amount of organic peroxide are selected in consideration of an amount of active —O—O— and a decomposition temperature.

A curing auxiliary to be used in this case may be a compound having a reaction activity with a peroxy radical and a polymer radical, and there are exemplified polyfunctional compounds having a functional group, for example, CH₂═CH—, CH₂═CHCH₂— and CF₂═CF—. Examples thereof are, for instance, triallyl cyanurate, triallyl isocyanurate (TAIC), triacryl formal, triallyl trimellitate, N,N′-n-phenylenebismaleimide, dipropargyl terephthalate, diallyl phthalate, tetraallyl terephthalateamide, triallyl phosphate, bismaleimide, fluorinated triallyl isocyanurate(1,3,5-tris(2,3,3-trifluoro-2-propenyl) 1,3,5-triazine-2,4,6-tr ion), tris(diallylamine)-S-triazine, triallyl phosphite, N,N-diallylacrylamide and 1,6-divinyldodecafluorohexane.

Examples of a curing agent used for the polyol crosslinking are polyalcohol compounds such as bisphenol A and bisphenol AF.

Examples of a curing agent used for the polyamine crosslinking are polyamine compounds such as hexamethylenediamine carbamate, N,N′-dicinnamilidene-1,6-hexanediamine and 4,4′-bis(aminocyclohexyl)methane carbamate.

Examples of a catalyst used for the triazine crosslinking are organotin compounds such as tetraphenyltin and triphenyltin.

Examples of a curing agent used for oxazole crosslinking system, imidazole crosslinking system or thiazole crosslinking system are a bisaminothiophenol curing agent, a bisaminophenol curing agent and a bisdiaminophenyl curing agent, those are represented by the general formula (3):

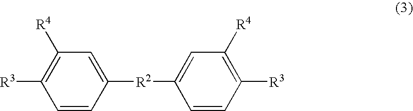

wherein R² is —SO₂—, —O—, —CO—, an alkylene group having 1 to 6 carbon atoms, a perfluoroalkylene group having 1 to 10 carbon atoms or a single bond, either R³ or R⁴ is —NH₂ and other one is —NH₂, —OH or —SH, and preferably both of R³ and R⁴ are —NH₂,
a bisamidrazone curing agent represented by the general formula (4):

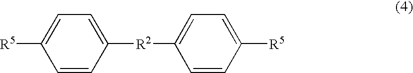

wherein R² is as defined above, R⁵ is

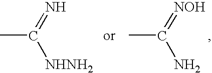

a bisamidoxime curing agent represented by the general formula (5):

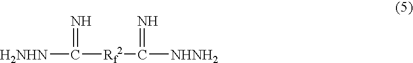

wherein R_{f}² is a perfluoroalkylene group having 1 to 10 carbon atoms, or the general formula (6):

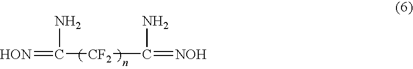

wherein n is an integer of 1 to 10. These bisaminophenol curing agent, bisaminothiophenol curing agent and bisdiaminophenyl curing agent are curing agents which have been used for crosslinking systems using a cyano group as a cure site and also react with a carboxyl group or an alkoxycarbonyl group to form an oxazole ring, a thiazole ring or an imidazole ring and give a crosslinked article.

An amount of the curing agent is preferably 0.05 to 10 parts by weight, more preferably 1 to 5 parts by weight based on 100 parts by weight of the fluorine-containing elastomer. When the amount of the curing agent is less than 0.05 part by weight, there is a tendency that the fluorine-containing elastomer is not crosslinked sufficiently, and when the amount of the curing agent exceeds 10 parts by weight, physical properties of a crosslinked article tend to be lowered.

When the sealing material is used on equipment generating plasma, the fluorine-containing elastomer may contain a compound having an effect of preventing oxidation by plasma.

When the sealing material is used especially in the field where a high purity and non-staining property are not required, usual additives blended to fluorine-containing elastomer compositions according to necessity, for example, a filler, a processing auxiliary, a plasticizer and a colorant can be blended to the composition, and in addition, one or more of usual crosslinking agents and crosslinking aids which differ from those mentioned above may be blended.

The sealing material of the present invention comprising the fluorine-containing elastomer can be prepared by usual method by mixing the above-mentioned components with a usual elastomer processing equipment, for example, an open roll, a Banbury mixer or a kneader. In addition, the sealing material can be prepared also by a method of using a closed mixer.

For producing a pre-molded article from the above-mentioned composition, usual known methods may be employed, such as a method of heating and compressing in a metal mold, a method of putting in a heated metal mold under pressure or a method of extruding with an extruder.

In the present invention, vulcanization conditions are not limited particularly, and for example, the following vulcanization conditions can be employed.

### (Standard Formulation)

Fluorine-containing elastomer: 100 parts by weight

Triallyl isocyanurate (TAIC): 2 parts by weight

Perhexa 25B: 1 part by weight

Filler: 15 parts by weight

### (Standard Vulcanization Condition)

Kneading method: Kneading by roll

Press vulcanization: at 160° C. for 7 minutes

Oven-vulcanization: at 180° C. for 4 hours

The sealing material of the present invention obtained by crosslinking and molding can be suitably used in the following fields.

In the fields of semiconductors such as semiconductor manufacturing equipment, liquid crystal panel manufacturing equipment, plasma panel manufacturing equipment, plasma address liquid crystal panel, field emission display panel and substrates of solar cells, there are exemplified O(square)-ring, packing and sealing material, which can be used on CVD equipment, dry etching equipment, wet etching equipment, oxidation/diffusion equipment, sputtering equipment, ashing equipment, washing equipment, ion implantation equipment, exhausting equipment, pipes for chemicals and gas pipes. Specifically the sealing material can be used as O-ring and sealing material of a gate valve, O-ring and sealing material of quartz window, O-ring and sealing material of a chamber, O-ring and sealing material of a gate, O-ring and sealing material of a bell jar, O-ring and sealing material of a coupling, O-ring and sealing material of a pump, O-ring and sealing material of gas control equipment for semiconductors and O-ring and sealing material for a resist developing solution and releasing solution.

The sealing material of the present invention can be suitably used especially as a sealing material for dovetail grooves since it can be mounted without torsion and degree of the torsion can be easily confirmed when mounting it.

### EXAMPLE

The present invention is then explained by means of Example, but the present invention is not limited thereto.

### Example 1

To 100 parts by weight of a fluorine-containing elastomer (DAIEL PERFLO GA-105 available from DAIKIN INDUSTRIES, LTD.) were mixed 2 parts by weight of triallyl isocyanurate (TAIC), 1 part by weight of 2,5-dimethyl-2,5-di(t-butylperoxy)hexane (Perhexa 25B available from NOF CORPORATION) and 15 parts by weight of carbon black N-990 (Cancarb Limited.), followed by kneading with an open roll to prepare a crosslinkable fluorine-containing elastomer composition.

This fluorine-containing elastomer composition was subjected to press-crosslinking at 160° C. for 7 minutes and then oven-crosslinking at 180° C. for 4 hours in an oven to produce a test sample of O-ring (P-24). This test sample was subjected to marking with YAG laser marker (MD-H9800 available from KEYENCE CORPORATION) (FIG. 1). The marked O-ring could be fitted to a dovetail groove without torsion.

### (Standard Formulation)

Fluorine-containing elastomer: 100 parts by weight

Triallyl isocyanurate (TAIC): 2 parts by weight

Perhexa 25B: 1 part by weight

Filler: 15 parts by weight

### (Standard Vulcanization Condition)

Kneading method: Kneading by roll

Press vulcanization: at 160° C. for 7 minutes

Oven-vulcanization: at 180° C. for 4 hours

### INDUSTRIAL APPLICABILITY

The sealing material of the present invention can be mounted without torsion because marking is provided on a surface of a seal ring along its shape and degree of the torsion can be easily confirmed when mounting it.

1. A sealing material comprising a fluorine-containing elastomer and having marking provided on a surface of a seal ring along a shape of the seal ring.

2. The sealing material of claim 1, wherein the marking is provided in series in a linear form along a shape of the seal ring in a plane view.

3. The sealing material of claim 1, wherein said fluorine-containing elastomer is a perfluoro elastomer.

4. The sealing material of claim 1, wherein the marking is made by laser printing.

5. The sealing material of claim 2, wherein said fluorine-containing elastomer is a perfluoro elastomer.

6. The sealing material of claim 2, wherein the marking is made by laser printing.

7. The sealing material of claim 3, wherein the marking is made by laser printing.

8. The sealing material of claim 5, wherein the marking is made by laser printing.
